(19) United States
(12) Patent Application Publication
(10) Pub. No.: US 2015/0276391 A1
(43) Pub. Date: Oct. 1, 2015

(54) DIRECTION DISCRIMINATION DEVICE, DIRECTION DISCRIMINATION METHOD, AND RECORDING MEDIUM STORING DIRECTION DISCRIMINATION CONTROL PROGRAM

(71) Applicant: FUJITSU LIMITED, Kawasaki-shi, Kanagawa (JP)

(72) Inventors: Yuichi Murase, Yokohama (JP); Katsushi Sakai, Zama (JP); Shan Jiang, Zama (JP)

(73) Assignee: FUJITSU LIMITED, Kawasaki-shi, Kanagawa (JP)

(21) Appl. No.: 14/434,898

(22) PCT Filed: Oct. 15, 2012
(86) PCT No.: PCT/JP2012/076608

§ 371 Date: Apr. 10, 2015

(51) Int. Cl. G01B 11/26

(52) U.S. Cl. CPC G01B 11/26

(57) ABSTRACT

A direction discrimination device, that includes: an optical receiver section that includes a plurality of photoelectric conversion sections outputting electrical signals according to an amount of light received as light reception amount data, and a polarization section causing mutually different polarization directions for light receivable by the plurality of respective photoelectric conversion sections, and that has an established second reference direction specifying the heading of each of the photoelectric conversion sections when receiving light; and a discrimination section that discriminates an angular displacement of the second reference direction with respect to a first reference direction, based on the light reception amount data obtained by the plurality of photoelectric conversion sections in a specific region and polarization direction data extracted from received light.

### CROSS-REFERENCE TO RELATED APPLICATION

This application is a continuation application of International Application No. PCT/JP/2012/076608, filed Oct. 15, 2012, the disclosure of which is incorporated herein by reference in its entirety.

### FIELD

The embodiments discussed herein are related to a direction discrimination device, a direction discrimination method, and a recording medium storing a direction discrimination control program.

### BACKGROUND

Sometimes a service is provided in which data related to an exhibit is presented via visuals and audio when facing the exhibit (referred to as a “data presentation service” below).

In a situation in which different data is provided for each of plural exhibits present in an exhibition hall, appropriate data presentation services are demanded by a person visiting the exhibition hall to appreciate the exhibits (referred to as a “user” below). Such cases need the relative positional relationship between the user and the exhibits to be specified, and need user position data including the direction the user is facing (for example, heading of the face).

A detection device that detects a relative angle in a measurement planar surface has been proposed as related technology that specifies the user position data. In this detection device, a polarized light source that radiates polarized light substantially orthogonal to the measurement planar surface, is received by a first optical reception element, second optical reception element, and a third optical reception element. The first optical reception element receives polarized light via a first polarizing filter, the second optical reception element receives light via a second polarizing filter, and the third optical reception element receives polarized light directly, enabling an angle relative to an initial direction to be calculated from a combination of the signal strengths of each of the optical reception elements.

A relative angle detection device provided with a polarizing plate-type angle detection device in each coordinate axis direction X, Y, Z, has been proposed as related technology that specifies other user position data.

A rotation angle gauge, in which luminescent elements and optical reception elements face each other at plural locations on equivalent circles on a rotating polarization plate, and fixed polarization plates with mutually different polarization angles are interposed on the respective optical axes thereof, has been proposed as related technology that specifies other user position data. In the rotation angle gauge, a device is proposed that recognizes a semi-circle angle of from 0° to 180° of the rotating polarization plate by processing respective signals when light from the luminescent elements is captured by the optical reception elements after passing through the rotating polarizing plate and the fixed polarizing plate.

Other related technology has been proposed of employing an image capture device able to acquire a polarization image and a color image simultaneously, and estimating the heading of the image capture device from a clear sky polarization image that is polarization data of a portion of the sky, and from a map indicating the polarization state of the sky resulting from the position of the sun at the time of image capture.

### RELATED PATENT DOCUMENTS

Japanese Patent Application Laid-Open (JP-A) No. H09-163268

JP-A No. H09-319505

JP-A No. 2008-298760

WO2010/079557

Utility Model Registration No. 3090450

### SUMMARY

According to an aspect of the embodiments, a direction discrimination device, includes: an illumination section that is disposed with an established first reference direction, that includes a light source emitting light of a predetermined polarization direction towards a specific region, and that superimposes polarization direction data identifying the polarization direction onto the emitted light and outputs the data-superimposed light; an optical receiver section that includes a plurality of photoelectric conversion sections outputting electrical signals according to an amount of light received as light reception amount data, and a polarization section causing mutually different polarization directions for light receivable by the plurality of respective photoelectric conversion sections, and that has an established second reference direction specifying the heading of each of the photoelectric conversion sections when receiving light; and a discrimination section that discriminates an angular displacement of the second reference direction with respect to the first reference direction, based on the light reception amount data obtained by the plurality of photoelectric conversion sections in the specific region and the polarization direction data extracted from received light.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating a configuration of a direction detection device according to a first exemplary embodiment;

FIG. 2 is a block diagram illustrating functions of a sensor processing controller of a direction detection device according to the first exemplary embodiment;

FIG. 3 is a block diagram illustrating a hardware configuration of a direction detection device according to the first exemplary embodiment;

FIG. 4 is a view of the appearance when a direction detection device is installed in an exhibition hall, according to the first exemplary embodiment;

FIG. 5 is a front view illustrating a state in which a headset is worn by a user according to the first exemplary embodiment;

FIG. 6 is a characteristic plot illustrating an identification signal of a position ID superimposed on light output from an optical anchor;

FIG. 7 is a characteristic plot illustrating transmission detection intensity by a linear polarizing filter;

FIG. 8 is a placement diagram of an optical system in a direction detection device according to the first exemplary embodiment;

FIG. 9 is a schematic diagram illustrating displacement with respect to a reference direction in an optical anchor according to the first exemplary embodiment;

FIG. 10 is a schematic diagram of when an angle difference between an optical anchor and an optical receiver is specified according to the first exemplary embodiment;

FIG. 11 is a schematic diagram of when a direction angle of an optical anchor is selected according to the first exemplary embodiment;

FIG. 12 is an output characteristic plot of a magnetic direction sensor according to the first exemplary embodiment;

FIG. 13 is a characteristic plot illustrating changing states of the detection direction according to the first exemplary embodiment;

FIG. 14 is a schematic diagram illustrating a relative positional relationship between a first linear polarizing filter and a first photodiode, and illustrating a photoelectric conversion circuit according to the first exemplary embodiment;

FIG. 15 is an optical receiver angle-detection voltage characteristic plot for a single photodiode according to the first exemplary embodiment;

FIG. 16 is an optical receiver angle-detection voltage characteristic plot for three photodiodes according to the first exemplary embodiment;

FIG. 17 is an enlarged view illustrating a portion of the optical receiver angles of the characteristic plot in FIG. 16;

FIG. 18 is a flowchart (part 1 thereof) illustrating a flow of direction detection control in a direction detection device according to the first exemplary embodiment;

FIG. 19 is a flowchart (part 2 thereof) illustrating a flow of direction detection control in a direction detection device according to the first exemplary embodiment;

FIG. 20 is a block diagram illustrating functions of a sensor processing controller of a direction detection device according to a second exemplary embodiment;

FIG. 21 is an optical receiver angle-detection voltage characteristic plot of three photodiodes according to the second exemplary embodiment;

FIG. 22 is a schematic diagram of an illuminance ratio-angle α table stored in an illuminance ratio-angle α table storage section according to the second exemplary embodiment;

FIG. 23 is a flowchart (part 1 thereof) illustrating a flow of direction detection control in a direction detection device according to the second exemplary embodiment;

FIG. 24 is a flowchart (part 2 thereof) illustrating a flow of direction detection control in a direction detection device according to the second exemplary embodiment;

FIG. 25 is a front view of a linear polarizing filter according to a third exemplary embodiment.

FIG. 26 is an optical receiver angle-detection voltage characteristic plot for five photodiodes according to the third exemplary embodiment;

FIG. 27 is an optical receiver angle-detection voltage characteristic plot for seven photodiodes according to a Modified Example 1 of the third exemplary embodiment; and

FIG. 28 is an optical receiver angle-detection voltage characteristic plot for nine photodiodes according to a Modified Example 2 of the third exemplary embodiment.

### DESCRIPTION OF EMBODIMENTS

### First Exemplary Embodiment

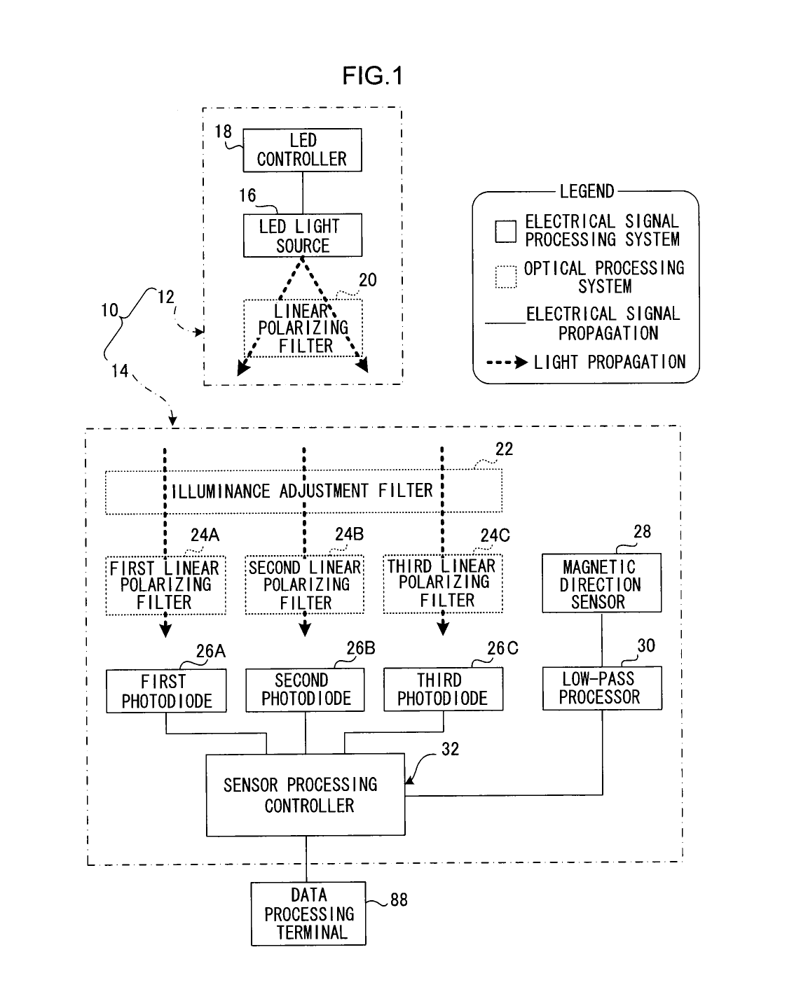

FIG. 1 is a system diagram of a direction detection device 10 according to a first exemplary embodiment.

The direction detection device 10 includes an optical anchor 12 fixed in a predetermined position, and a movable optical receiver 14. The optical anchor 12 functions as an example of an illumination section of technology disclosed herein. The optical receiver 14 functions as an example of an optical receiver section and a discrimination section of technology disclosed herein.

The direction detection device 10 uses the optical anchor 12 as a reference, specifies the heading of the optical receiver 14 using light received by the optical receiver 14 from the optical anchor 12, and magnetic direction.

As illustrated in FIG. 1, the optical anchor 12 includes an LED light source 16, an LED controller 18, and a linear polarizing filter 20.

The optical receiver 14 includes an illuminance adjustment filter 22, a first linear polarizing filter 24A, a second linear polarizing filter 24B, and a third linear polarizing filter 24C. The first linear polarizing filter 24A, the second linear polarizing filter 24B, and the third linear polarizing filter 24C function as examples of polarization sections of technology disclosed herein.

The optical receiver 14 includes a first photodiode 26A, a second photodiode 26B, and a third photodiode 26C. The first photodiode 26A, the second photodiode 26B, and the third photodiode 26C function as examples of photoelectric conversion sections of technology disclosed herein.

The optical receiver 14 includes a magnetic direction sensor 28, a low-pass processor 30, and a sensor processing controller 32. The magnetic direction sensor 28 functions as an example of a magnetic direction region detection section of technology disclosed herein.

The sensor processing controller 32 is connected to a data processing terminal 88.

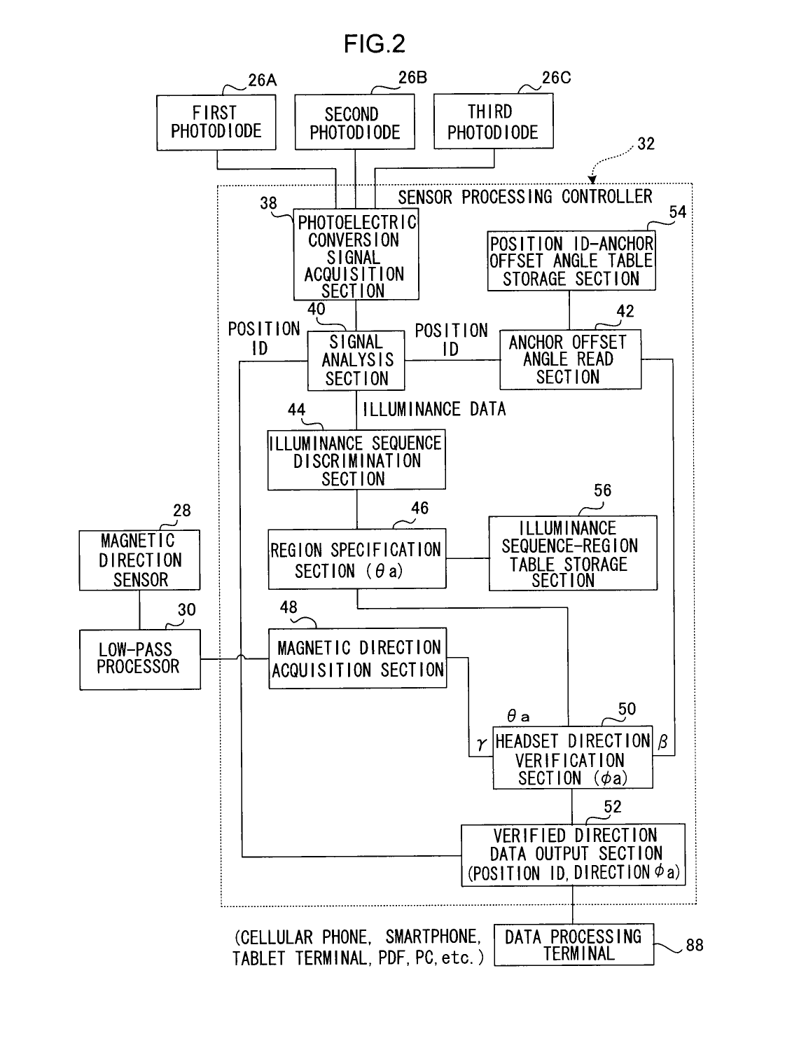

As illustrated in FIG. 2, the sensor processing controller 32 includes a photoelectric conversion signal acquisition section 38, a signal analysis section 40, an anchor offset angle read section 42, an illuminance sequence discrimination section 44, a region specification section 46, a magnetic direction acquisition section 48, a headset direction verification section 50, and a verified direction data output section 52.

The sensor processing controller 32 includes a position ID-anchor offset angle table storage section 54, and an illuminance sequence-region table storage section 56.

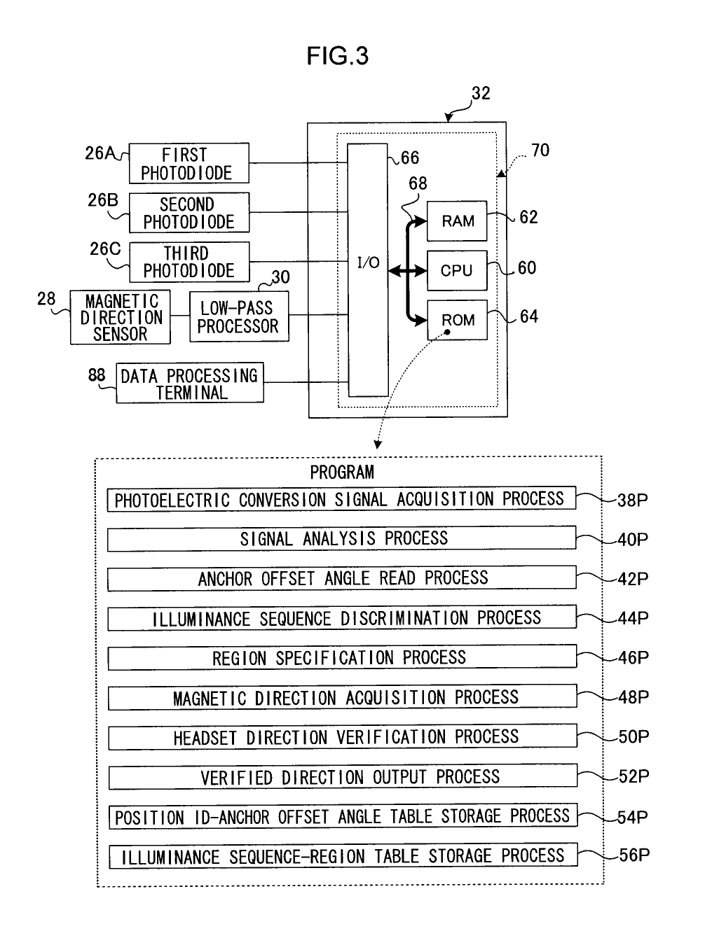

As illustrated in FIG. 3, the sensor processing controller 32 of the optical receiver 14 includes a microcomputer 70 provided with a CPU 60, RAM 62, ROM 64, and an I/O 66, mutually connected by a bus 68, such as a data bus or a control bus.

Sometimes the storage capacity of the ROM 64 is supplemented by connecting an interface that connects to a storage medium, such as a HDD, SD memory, or USB memory, to the I/O of the microcomputer 70. For example, a HDD may be connected so as to function as the storage medium for the position ID-anchor offset angle table storage section 54 and the illuminance sequence-region table storage section 56.

As illustrated in FIG. 3, a direction detection control program executed by the sensor processing controller 32 includes a photoelectric conversion signal acquisition process 38P, a signal analysis process 40P, and an anchor offset angle read process 42P.

The direction detection control program executed by the sensor processing controller 32 includes an illuminance sequence discrimination process 44P, and a region specification process 46P.

The direction detection control program executed by the sensor processing controller 32 includes a magnetic direction acquisition process 48P, a headset direction verification process 50P, and a verified direction output process 52P.

The direction detection control program executed by the sensor processing controller 32 includes a position ID-anchor offset angle table storage process 54P, and an illuminance sequence-region table storage process 56P.

The CPU 60 operates as the photoelectric conversion signal acquisition section 38 illustrated in FIG. 2 by executing the photoelectric conversion signal acquisition process 38P.

The CPU 60 operates as the signal analysis section 40 illustrated in FIG. 2 by executing the signal analysis process 40P.

The CPU 60 operates as the anchor offset angle read section 42 illustrated in FIG. 2 by executing the anchor offset angle read process 42P.

The CPU 60 operates as the illuminance sequence discrimination section 44 illustrated in FIG. 2 by executing the illuminance sequence discrimination process 44P.

The CPU 60 operates as the region specification section 46 illustrated in FIG. 2 by executing the region specification process 46P.

The CPU 60 operates as the magnetic direction acquisition section 48 illustrated in FIG. 2 by executing the magnetic direction acquisition process 48P.

The CPU 60 operates as the headset direction verification section 50 illustrated in FIG. 2 by executing the headset direction verification process 50P.

The CPU 60 operates as the verified direction data output section 52 illustrated in FIG. 2 by executing the verified direction output process 52P.

The CPU 60 operates as the position ID-anchor offset angle table storage section 54 illustrated in FIG. 2 by executing the position ID-anchor offset angle table storage process 54P.

The CPU 60 operates as the illuminance sequence-region table storage section 56 illustrated in FIG. 2 by executing the illuminance sequence-region table storage process 56P.

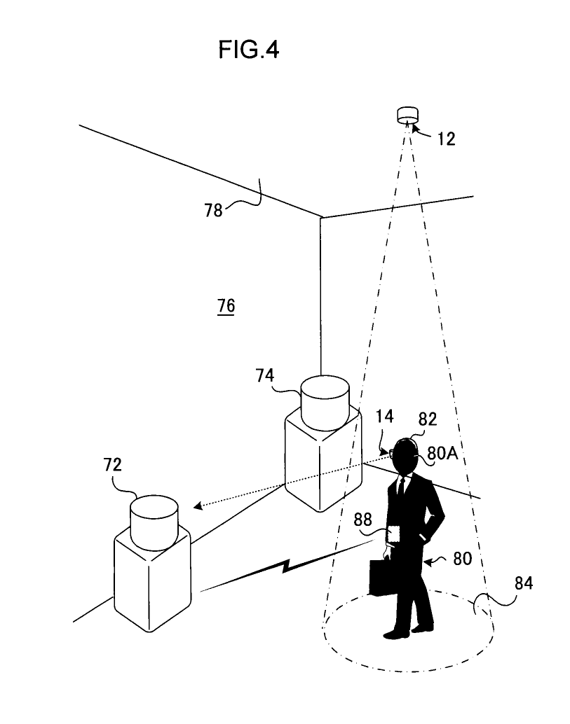

As illustrated in FIG. 4, as an example, the direction detection device 10 is placed indoors inside an exhibition hall 76 for appreciating plural exhibits 72, 74. The exhibits 72, 74 are not limited to 2 items, and there may be three or more items.

Inside the exhibition hall 76, the optical anchor 12 is fixed to a ceiling surface 78 of the exhibition hall 76.

The optical anchor 12 establishes a reference direction, and the difference between the reference direction and a specific direction (for example, North) in the exhibition hall 76 is known in advance (referred to as “anchor offset angle β” below).

The optical receiver 14 is affixed to a so-called wearable headset 82 that may be worn by a person (referred to as “user 80” below) visiting the exhibition hall 76 for appreciating the exhibits 74, 76. The optical receiver 14 is thereby moved through the exhibition hall 76 while being worn by the user 80. The optical receiver 14 also has an established reference direction. The reference direction of the optical receiver 14 is the forward facing direction of the user 80 when wearing the headset 82. The user 80, for example, carries the data processing terminal 88.

The optical receiver 14 obtains verified direction data (position data related to the optical anchor 12, and a direction angle in which the user 80 is facing) from light received from the optical anchor 12. The verified direction data is transmitted to the data processing terminal 88 by wired or wireless transmission. The data processing terminal 88 can specify the exhibit 72 (or 74) based on received verified direction data, and receive a data service related to the exhibit 72 (or 74).

Light is illuminated toward a floor surface 84 from the optical anchor 12, and the light flux area spreads out progressively (see the dot-dashed line in FIG. 4), enabling spotlight-like illumination toward the floor surface 84. The optical receiver 14 receives light illuminated from the optical anchor 12 by the user 80 wearing the headset 82 entering the light flux area. In other words, the user 80 may enter the light flux area from any direction.

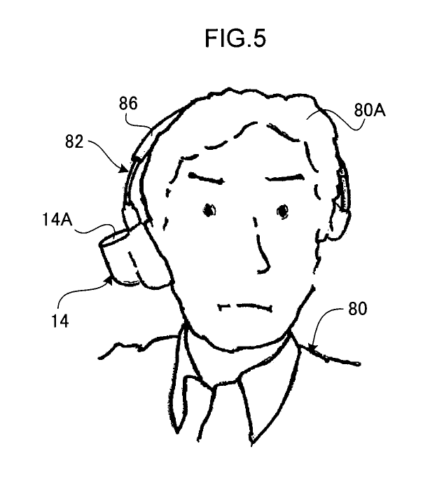

As illustrated in FIG. 5, the headset 82 is worn on the head 80A of the user 80. The headset 82 includes a headband portion 86, worn as an arch, shaped to follow the head 80A of the user 80. The headband portion 86 has elasticity to enable the radius to extend or contract, and the headband portion 86 is retained on the head 80A by the elasticity.

The optical receiver 14 is affixed to one end portion of the headband portion 86, with a light reception face 14A facing upward such that light illuminated from the optical anchor 12 (see FIG. 4) can be received by the optical receiver 14.

Since the user 80 wears the headset 82, the relative positional relationship between the head 80A of the user 80 and the optical receiver 14 is maintained, and the forward facing heading of the user 80 is always the reference direction described above.

The configuration to retain the headset 82 on the head 80A of the user 80 is not limited to the headband portion 86; other retention modes may be employed, such as a neckband-model, an ear clip-model, an earphone-model, or a browband-model. The optical receiver 14 may also be attached to an existing article, such as glasses, a hat, or a helmet, via an attachment clip.

Function of the Optical Anchor 12

As illustrated in FIG. 1, the light emission intensity (illuminance) of the LED light source 16 is controlled by the LED controller 18. In the first exemplary embodiment, the light emission pattern of the LED light source 16 includes a position ID of the optical anchor 12. The position ID is, for example, identifies planar position coordinates of the exhibition hall 76 and the anchor offset angle β.

In the LED controller 18, a light emission pattern is generated by controlling whether the LED light source is ON or OFF. The ON/OFF control corresponds to bit signals (a binary signal of “1” or “0”). Position IDs can thereby be superimposed on light illuminated from the optical anchor 12 as combinations of “1”s and “0”s.

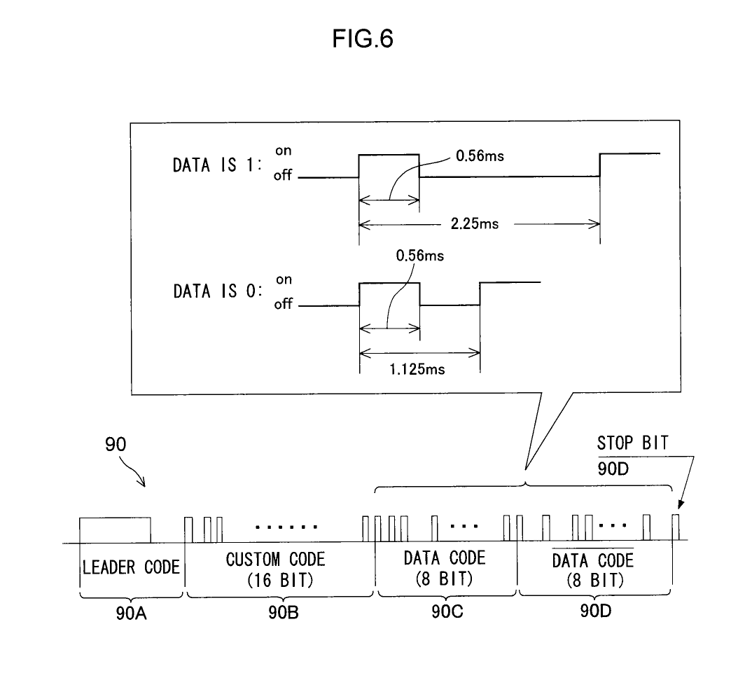

As illustrated in FIG. 6, as an example, data (“1” or “0”) are distinguished by the length of a single cycle (by the length of OFF time in one cycle).

Namely, suppose the single cycle is 2.25 ms with an ON time of 0.56 ms when the data is “1”, and the single cycle is 1.125 ms with an ON time of 0.56 when the data is “0”. Identification of “1” or “0” can thereby be made due to the difference in the two OFF times. Provided that “1” and “0” can be identified, the values of the cycles are not limited to the above.

A lighting control signal 90 of the LED light source 16 is generated based on a predetermined format, using the position IDs generated by the “1”/“0” signal as the base. As illustrated in FIG. 6, the lighting control signal 90 is divided into, for example, a reader code region 90A, a custom code region (16 bit) 90B, plural data code regions (8 bit) 90C, and a stop bit 90D.

Light is output through the linear polarizing filter 20 when the LED light source 16 is switched on based on the lighting control signal generated by the LED controller 18. As illustrated in FIG. 4, in the first exemplary embodiment, the LED light source 16 faces the floor surface 84 of the exhibition hall 76, and the spreading light is illuminated toward the floor surface 84.

The linear polarizing filter 20 is a filter that specifies the polarization direction of light illuminated from the LED light source 16, and light matching the polarization direction of the linear polarizing filter 20 is output with the greatest intensity, and light orthogonal to the polarized direction is output with the lowest intensity.

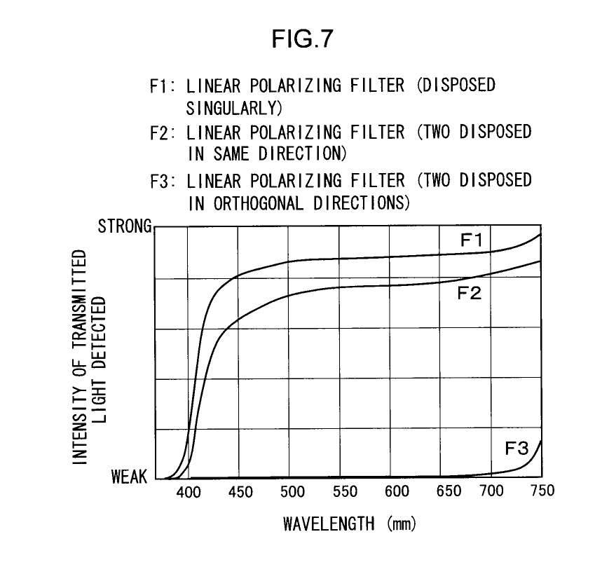

FIG. 7 illustrates examples of transmission characteristics of a linear polarizing filter applicable as the linear polarizing filter 20. The horizontal axis in FIG. 7 is wavelength, and the vertical axis is the intensity (illuminance) of the transmitted light.

Intensity characteristics for light transmitted through a single linear polarizing filter (characteristics F1) are illustrated in the transmission characteristics of the linear polarizing filter in FIG. 7. The transmission characteristics of linear polarizing filters in FIG. 7 also illustrate intensity characteristics for light transmitted through two linear polarizing filters with matching polarization directions (characteristics F2). The transmission characteristics of linear polarizing filters in FIG. 7 also illustrate intensity characteristic for light transmitted through two linear polarizing filters with orthogonal polarization directions (characteristics F3).

As is apparent from characteristics F1 to characteristic F3 in FIG. 7, it is apparent that incident light is transmitted when the light has a polarization direction matching the linear polarizing filter. It is also apparent that light is transmitted when two linear polarizing filters have matching polarization directions. It is also apparent that light is blocked when the polarization directions of two linear polarizing filters are orthogonal to each other.

Thus, for light transmitted by the linear polarizing filter 20, namely, for light output from the optical anchor 12, onward transmission at a downstream side through a filter having a different polarization direction enables the intensity of light transmitted through the downstream filter to be modified.

Function of the Optical Receiver 14

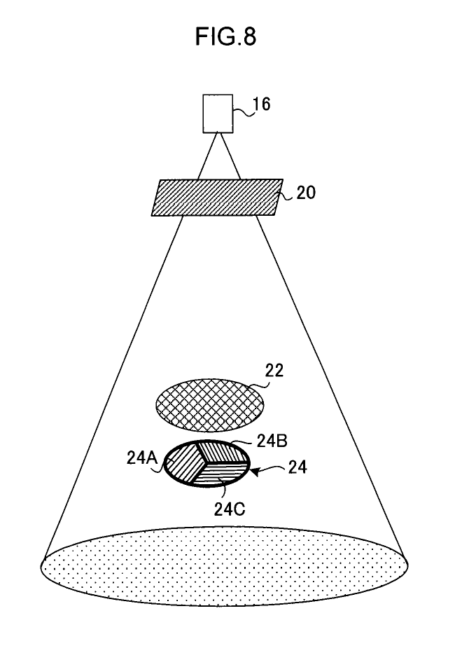

FIG. 8 illustrates a placement relationship between the optical anchor 12 and components in the optical system of the optical receiver 14. A round plate shaped polarizing filter unit 24 is affixed at the light reception face 14A of the optical receiver 14 of the first exemplary embodiment, with the illuminance adjustment filter 22 in between. For example, an ND filter that attenuates the intensity of light incident to the optical receiver 14 may be applied as the illuminance adjustment filter 22.

The polarizing filter unit 24 is uniformly divided along its circumference into three, and linear polarizing filter regions with mutually different linear polarization directions are provided with 120° center angles. The linear polarization filter regions are referred to below as a first linear polarizing filter 24A, a second polarizing filter 24B, and a third polarizing filter 24C respectively (see FIG. 1).

The first linear polarizing filter 24A, the second linear polarizing filter 24B, and the third linear polarizing filter 24C are each fan shaped. The polarization directions of the first linear polarizing filter 24A, the second linear polarizing filter 24B, and the third linear polarizing filter 24C are each shifted 60° with respect to one another. Provided that three polarization direction segments are formed, the polarizing filter unit 24 does not need to be circular plate shaped.

Thus, by rotating the polarizing filter unit 24 by, for example, 360°, the polarization directions of the first linear polarizing filter 24A, the second linear polarizing filter 24B, and the third linear polarizing filter 24C are also rotated at the same time by 360°. In the first exemplary embodiment, “rotation” is rotation about a rotation axis orthogonal to the circumferential plane of the polarizing filter unit 24, resulting from displacement caused by the heading of the head 80A of the user 80 changing.

In the optical receiver 14, a first photodiode 26A, a second photodiode 26B, and a third photodiode 26C are disposed facing the first linear polarizing filter 24A, the second linear polarizing filter 24B, and the third linear polarizing filter 24C respectively.

As illustrated in FIG. 2, the first photodiode 26A, the second photodiode 26B, and the third photodiode 26C are connected to the photoelectric conversion signal acquisition section 38 of the sensor processing controller 32. Electrical signals according to the illuminance of light detected by the respective first photodiode 26A, the second photodiode 26B, and the third photodiode 26C are acquired by the photoelectric conversion signal acquisition section 38.

The photoelectric conversion signal acquisition section 38 is connected to the signal analysis section 40. The signal analysis section 40 analyzes the position ID and the illuminance data. The signal analysis section 40 is connected to the anchor offset angle read section 42. The signal analysis section 40 transmits the position ID to the anchor offset angle read section 42. The signal analysis section 40 is connected to the illuminance sequence discrimination section 44. The signal analysis section 40 transmits the illuminance data to the illuminance sequence discrimination section 44. The signal analysis section 40 is connected to the verified direction data output section 52. The signal analysis section 40 transmits the position ID to the verified direction data output section 52.

The anchor offset angle read section 42 is connected to the position ID-anchor offset angle table storage section 54. The position ID-anchor offset angle table storage section 54 stores relationships between position IDs and anchor offset angles (β) in the form of a table. The anchor offset angle read section 42 accordingly reads the anchor offset angle β corresponding to the position ID, from the position ID-anchor offset angle table storage section 54, for transmission to the headset direction verification section 50.

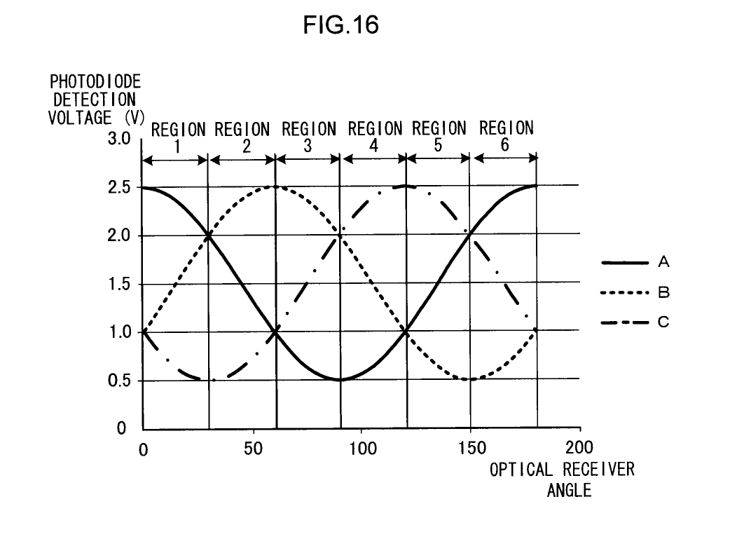

The illuminance sequence discrimination section 44 discriminates an illuminance sequence (a sequence of light intensities) based on the illuminance data, and transmits the discrimination result to the region specification section 46. The illuminance sequence-region table storage section 56 is connected to the region specification section 46, and a region θa (see FIG. 16, and Table 1, described later) is specified by the region specification section 46 based on the discrimination result. The region θa specified in the region specification section 46 is transmitted to the headset direction verification section 50.

The optical receiver 14 is provided with the magnetic direction sensor 28, a signal detected using the magnetic direction sensor 28 and converted to a waveform by the low-pass processor 30 is transmitted to the magnetic direction acquisition section 48. The magnetic direction γ acquired by the magnetic direction acquisition section 48 is transmitted to the headset direction verification section 50.

When respective data of the region θa, the anchor offset angle β, and the magnetic direction γ are collected in the headset direction verification section 50, the headset direction φa is verified and transmitted to the verified direction data output section 52. The headset direction φa indicates any angle range based on the regions θa (1 to 6) illustrated in FIG. 16.

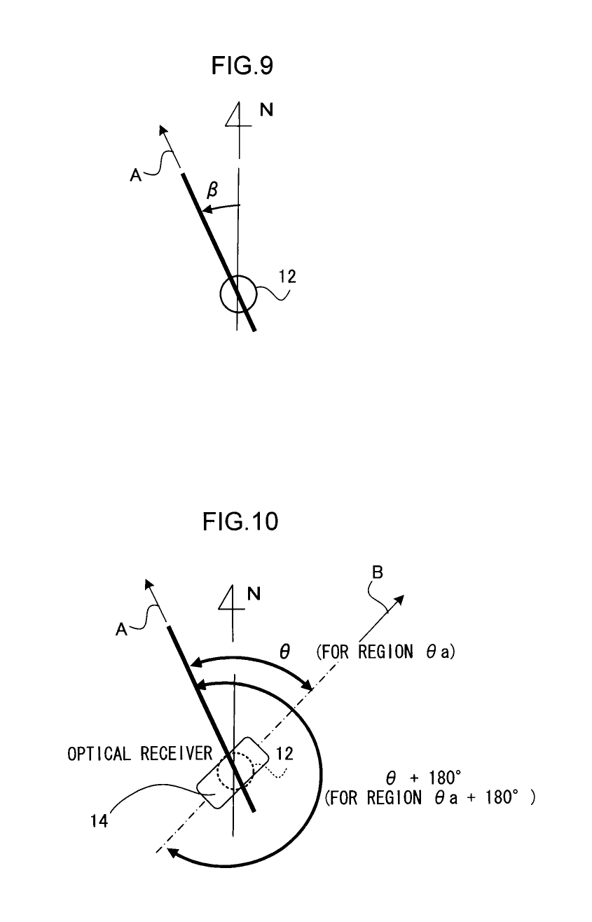

FIG. 9 to FIG. 11 illustrate an example of the headset direction verification section 50.

As illustrated in FIG. 9, the LED controller 18 of the optical anchor 12 registers, as a single position ID, the anchor offset angle β, this being the angle difference between magnetic direction north (N) serving as the reference point and a first reference direction (the arrow A direction in FIG. 9 to FIG. 11) arising from the attachment state of the optical anchor 12. Note that the optical anchor 12 is not installed such that the first reference direction matches north.

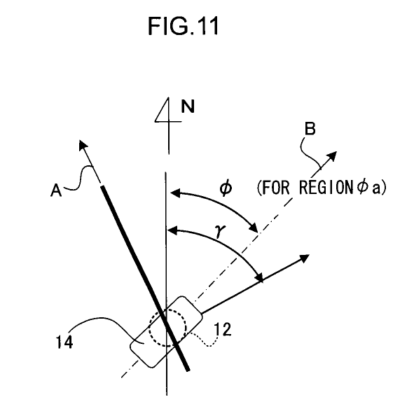

Next, as illustrated in FIG. 10, the sensor processing controller 32 specifies the angle that a second reference direction (the arrow B direction in FIG. 10, and FIG. 11) set in the optical receiver 14 faces when the optical receiver 14 has entered a region of light illuminated from the optical anchor 12 (in this example a region θa or θa+180° when 360° is divided into 12).

However, light passing through the first linear polarizing filter 24A, the second linear polarizing filter 24B, and the third linear polarizing filter 24C in the optical receiver 14 has a period of 180°. Thus it is indistinguishable as to whether the heading of the optical receiver 14 is θa (referred to as the “forward direction” below), or θa+180° that is directly behind (referred to as the “reverse direction” below). Note that θa indicates one of the divided angle ranges 1 to 6 illustrated in FIG. 16.

As illustrated in FIG. 11, the sensor processing controller 32 discriminates between forward direction and reverse direction using the estimated magnetic direction γ. Namely, comparison is made between the estimated magnetic direction γ and the heading θa and the heading θa+180° respectively, and the heading with the smallest difference (the closest heading) can be specified as the direction φ in which the optical receiver 14 is facing.

Although it is not possible to specify the estimated magnetic direction γ as a precise magnetic direction, the magnetic direction is detectable as belonging to one out of at least two regions (180° units) divided from the total circumference (360°). For example, it is sufficient to be able to detect whether the magnetic direction faces upwards (north facing) or downwards (south facing) with respect to a reference line (east-west line).

In the verified direction data output section 52, the verified direction data (the position ID and the headset direction φ) is transmitted to the data processing terminal 88. After receiving the verified position data, the data processing terminal 88 specifies the exhibit 72 (or 74), and executes processing to receive the data service for the corresponding exhibit 72 (or 74).

Example of the Direction Determination of the Magnetic Direction Sensor 28

The (estimated) magnetic direction γ detected by the magnetic direction sensor 28 is mediated by the low-pass processor 30, resulting in poor responsiveness to movement of the head 80A of the user 80 wearing the headset 82.

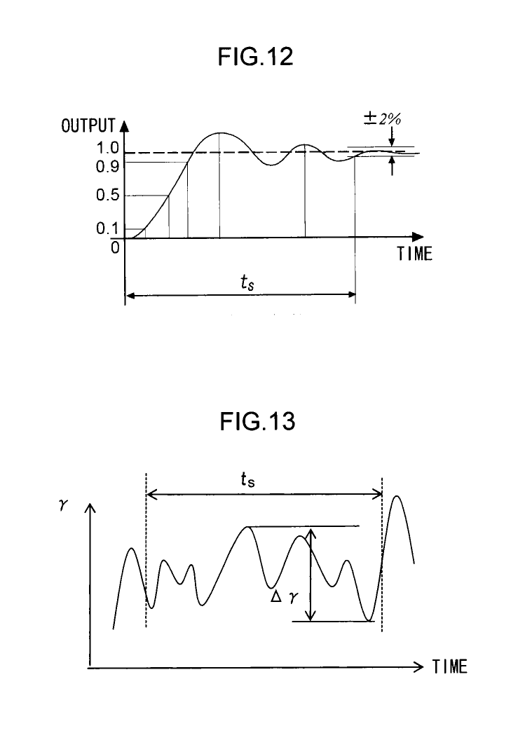

FIG. 12 is a diagram illustrating a transition of an output signal that has passed through the low-pass processor 30 (a low-pass filter) as detected by the magnetic direction sensor 28, and it is clear that, following the change in magnetic direction, the output signal progressively converges until stabilized. In FIG. 12, stabilization is considered complete when variations become ±2% (at a stabilization time ts).

In other words, unstable elements of the detected magnetic direction data are large when the stabilization time ts has not elapsed, such that it is not possible to apply the magnetic direction data as the magnetic direction γ. As illustrated in FIG. 13, for a time period equivalent to the stabilization time ts, the magnetic direction data is therefore applied as the magnetic direction γ under condition that displacement of magnetic direction angle Δγ is maintained at a predetermined angle or below (for example, Δγ≦45°).

This is because the detection output of the magnetic direction sensor 28 converges if the stabilization time ts has elapsed, and, if Δγ is stable (Δγ≦45°) for a time period equivalent to the stabilization time ts, it may be determined that the user 80 has not performed any actions such as a large oscillation of the head.

Example of the Photoelectric Conversion Signal Acquisition Section 38

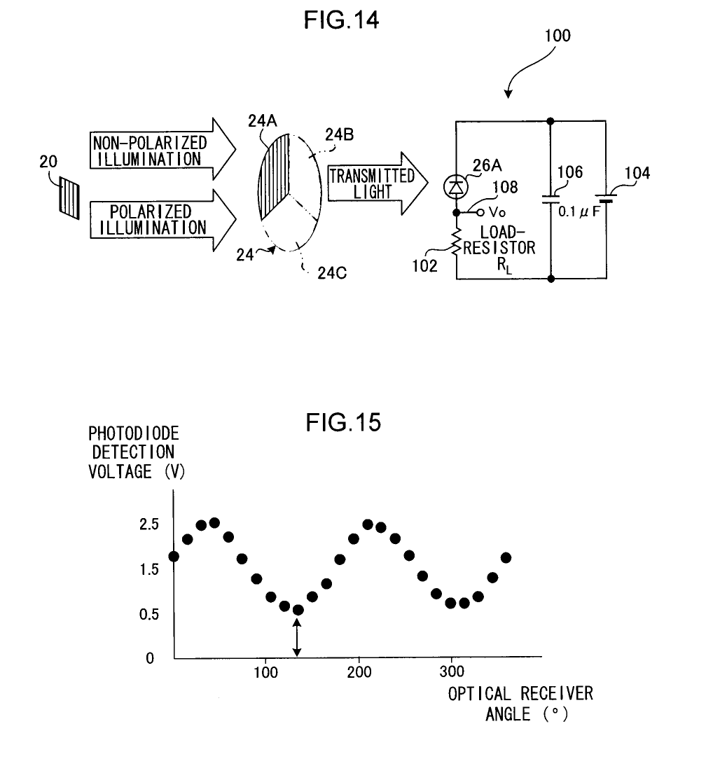

As an example, FIG. 14 illustrates an optical path diagram for light transmitted through the first linear polarizing filter 24A and incident to the first photodiode 26A. Note that light incident to the second photodiode 26B transmitted through the second linear polarizing filter 24B follows a similar light path, and explanation thereof is therefore omitted. Light incident to the third photodiode 26C transmitted through the third linear polarizing filter 24C also follows a similar light path, and explanation thereof is therefore omitted.

As illustrated in FIG. 14, the first photodiode 26A is wired as a portion of a photoelectric conversion circuit 100. One terminal of a load-resistor 102 is connected to the anode side of the first photodiode 26A. The cathode side of the first photodiode 26A is connected to the positive side terminal of a power source 104. The other terminal of the load-resistor 102 is connected to the negative side terminal of the power source 104. A capacitor 106 is interposed between the positive side and the negative side of the power source 104. A signal take-out line 108 is connected between the anode of the first photodiode 26A and the load-resistor 102. Thus an electrical signal (a detection voltage), according to the intensity of light received by the first photodiode 26A, is taken out through the signal take-out line 108.

Examples of the Illuminance Sequence Discrimination Section 44, and the Region Specification Section 46

FIG. 15 illustrates a characteristic plot for the detection voltage taken out through the signal take-out line 108 when the polarizing filter unit 24 (the first linear polarizing filter 24A) is rotated. Note that the detection voltage is dependent on the voltage of the power source 104, and a maximum amplitude of 2.0V is used here.

In addition to light from the optical anchor 12 (polarized illumination), light from ambient lighting (non-polarized illumination) is also incident to the first photodiode 26A. Thus, in the detection voltage characteristic plot, from a state elevated thereby (for example, an intensity of from approximately 0.5V to 0.6V in FIG. 15), intensity then varies in the form of a sine wave with a 180° period with respect to rotation of the polarizing filter unit 24, and a maximum intensity of 2.5V.

The illuminance adjustment filter 22 described above has a role of reducing the overall light such that the intensity detected by the first photodiode 26A is not saturated by the ambient lighting.

The first linear polarizing filter 24A, the second linear polarizing filter 24B, and the third linear polarizing filter 24C each form a fan shape, and fitting these to the single polarizing filter unit 24 gives linear polarizing filters shifted by 60° units with respect to one another. The characteristics of FIG. 15 are accordingly preserved when the single polarizing filter unit 24 is rotated, with the phase of each shifted from each other in the 60° units (see FIG. 16).

As is apparent from FIG. 16, the relative relationships between the intensity of light passing through the three filters, namely the first linear polarizing filter 24A, the second linear polarizing filter 24B, and the third linear polarizing filter 24C, change every 30°. Table 1 is an example of a table listing illuminance sequences using changes in illuminance sequence stored in the illuminance sequence-region table storage section 56.

TABLE 1

| Detection | θa | | | | | |
|---|---|---|---|---|---|---|
| Illuminance | Region 1 (°) | Region 2 (°) | Region 3 (°) | Region 4 (°) | Region 5 (°) | Region 6 (°) |
| (Intensity) | 0 to 30 | 30 to 60 | 60 to 90 | 90 to 120 | 120 to 150 | 150 to 180 |
| Greatest | A | B | B | C | C | A |
| Intermediate | B | A | C | B | A | C |
| Lowest | C | C | A | A | B | B |

A optic system with detection by the first photodiode 26A
B optic system with detection by the second photodiode 26B
C optic system with detection by the third photodiode 26C

The relative relationships between the intensity of light passing through the first linear polarizing filter 24A, the second linear polarizing filter 24B, and the third linear polarizing filter 24C illustrated in FIG. 16 presume that there are differences in intensity of a level capable of discrimination.

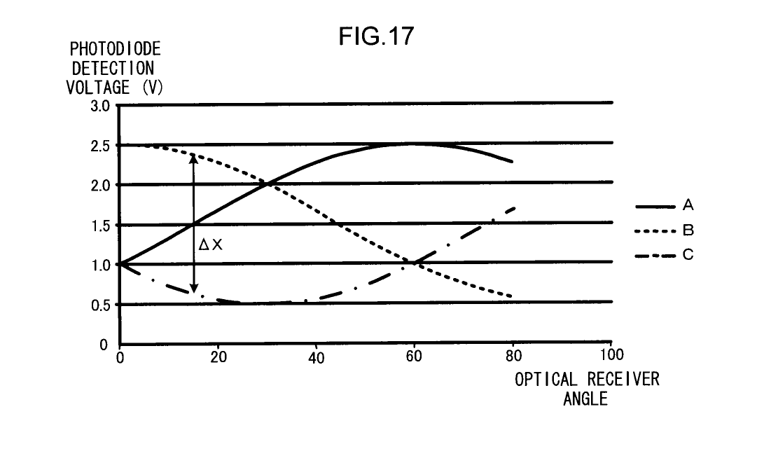

The sensitivities of the first photodiode 26A, the second photodiode 26B, and the third photodiode 26C are therefore preferably adjusted such that the difference ΔX between the greatest intensity and the lowest intensity is a stipulated detection voltage X0 or greater across an entire cycle as illustrated in FIG. 17. The stipulated detection voltage X0 may be modified according to the environment in which the direction detection device 10 is applied. In addition to sensitivity adjustment of the first photodiode 26A, the second photodiode 26B, and the third photodiode 26C on the optical receiver 14 side, sensitivity adjustment also includes adjustment of the light emission intensity from the optical anchor 12.

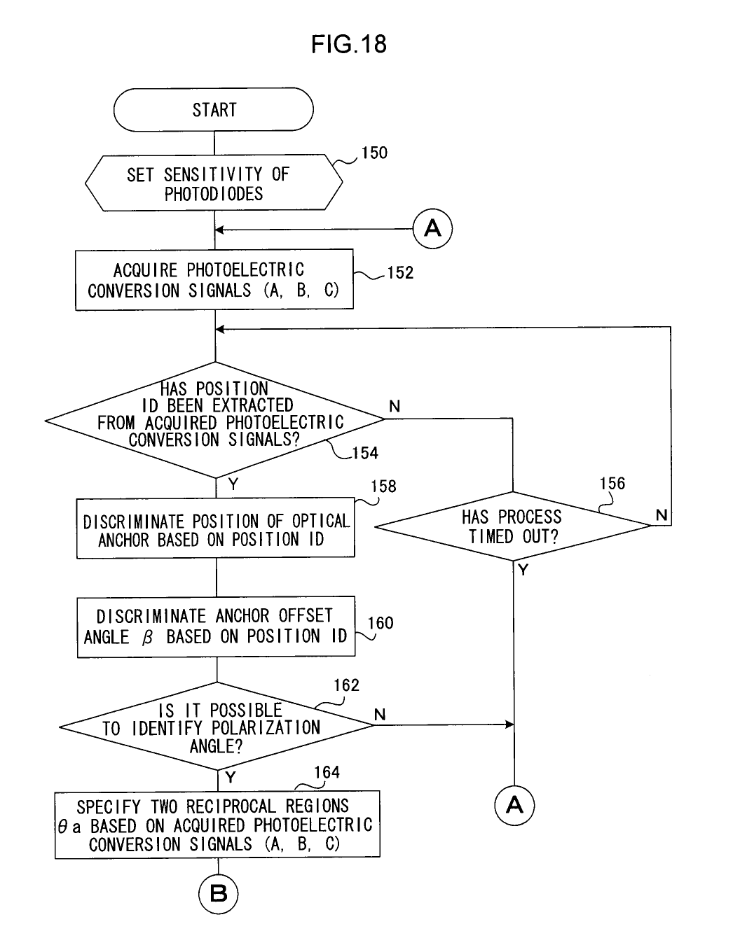

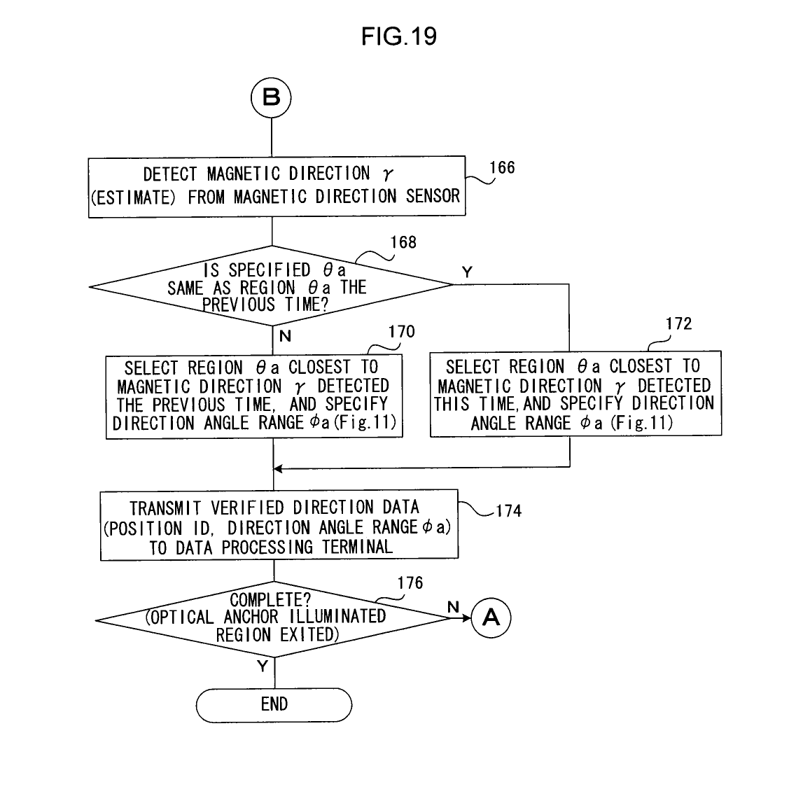

Explanation follows regarding operation of the first exemplary embodiment, according to the flowchart of FIG. 18 and FIG. 19.

As illustrated in FIG. 18, at step 150, sensitivity setting is performed for the photodiodes (the first photodiode 26A, the second photodiode 26B, and the third photodiode 26C). In the sensitivity setting, sensitivity is set such that the output (detection voltage) of the photoelectric conversion signals are not saturated, and the difference ΔX between the greatest value and the lowest value is the predetermined stipulated detection voltage X0 or greater (see FIG. 17).

Next, at step 152, the photoelectric conversion signals detected by the photodiodes (the first photodiode 26A, the second photodiode 26B, and the third photodiode 26C) are acquired, and processing transitions to step 154.

At step 154, determination is made as to whether or not the position ID has been extracted from the acquired photoelectric conversion signals (the received light). When negative determination is made at step 154, processing transitions to step 156 and determination is made as to whether or not processing has timed out. Affirmative determination at step 156 means that it is not possible to extract the position ID within a set time, namely, determination is made that no one (no optical receiver 14) has entered the light flux area illuminated from the optical anchor 12, and processing returns to step 152. Processing returns to step 154 when negative determination is made at step 156.

When affirmative determination is made at step 154, namely, when the position ID has been extracted, processing transitions to step 158, the position of the optical anchor 12 is discriminated based on the position ID, processing then transitions to step 160, and the anchor offset angle β is discriminated based on the position ID.

At the next step 162, determination is made as to whether or not the polarization angle can be identified based on the intensity differences between the three types of acquired photoelectric conversion signal. Processing returns to step 152 when negative determination is made at step 162.

Processing transitions to step 164 when affirmative determination is made at step 162, and two reciprocal regions θa are specified based on the intensity differences between the acquired photoelectric conversion signals (A, B, C) (see FIG. 16, Table 1). At this point in time, the direction in which the user 80 is facing is recognized as being one region out of the region θa and the region θa+180° that is 180° opposite thereto.

Processing transitions to step 166 of FIG. 19 when the 2 regions θa are specified at step 164.

As illustrated in FIG. 19, at step 166, the magnetic direction γ is detected from the magnetic direction sensor 28, and processing transitions to step 168.

At step 168, determination is made as to whether or not the region θa that has been specified the current time is the same region θa that was specified the previous time. Although this is to recognize a state of change in heading due to head oscillation or the like of the user 80, when close to a boundary line between the regions θa, the region θa of the previous time and the region θa of the current time may be different even with small changes, and so an error range is employed.

Since negative determination at step 168 indicates an abrupt change in the heading of the user 80, determination is therefore made that the detected magnetic direction is unstable (see FIG. 12, FIG. 13). Processing then transitions to step 170, the region θa closest to the magnetic direction γ detected the previous time is selected, the region φa is specified (see FIG. 11), and processing transitions to step 174.

Since affirmative determination at step 168 indicates that there is little change in the heading of the user 80, determination is made that the detected magnetic direction is stable (see FIG. 12, FIG. 13). Then, processing transitions to step 172, the region θa closest to the magnetic direction γ detected the current time is selected, the region φa is specified (see FIG. 11), and processing transitions to step 174.

Verified direction data (the position ID (the position coordinates of the optical anchor 12) and the region φa) is transmitted to the data processing terminal 88 at step 174, and processing then transitions to step 176. After receiving the verified direction data, the data processing terminal 88, for example, specifies from a database the exhibit 72 (or 74) present in the direction the user 80 faces toward, and the data for the exhibit 72 (or 74) is downloaded and presented to the user 80. Note that the data may be received from the exhibit 72 (or 74) directly.

At step 176, determination is made as to whether or not the illuminated region (light flux area) of the optical anchor 12 has been exited, and when negative determination is made, processing returns to step 152 and the above processes are repeated. The present routine ends when affirmative determination is made at step 176.

Since magnetism, which has varying errors depending on location and is slow to respond, is not directly employed as absolute direction data in the first exemplary embodiment, orientation drift data can be reset using data from polarized light, detectable with a fast response and stable direction, in contrast to configurations in which drift in orientation detection employing inertia sensors employing a triaxial gyro and a triaxial accelerometer is suppressed by a triaxial magnetic sensor (referred to below as “triaxial sensors”). Accordingly, a wide-area data presentation service is achievable that resets any directional drift when polarized light is detected.

### Second Exemplary Embodiment

Explanation follows regarding a second exemplary embodiment. In the second exemplary embodiment, configuration portions similar to those described in the first exemplary embodiment are appended with the same reference numerals, and explanation of the configuration thereof is omitted.

In the second exemplary embodiment, a more detailed heading of the user 80 (angle θ) is calculated using the region θa that is the heading of the user 80 specified in the first exemplary embodiment.

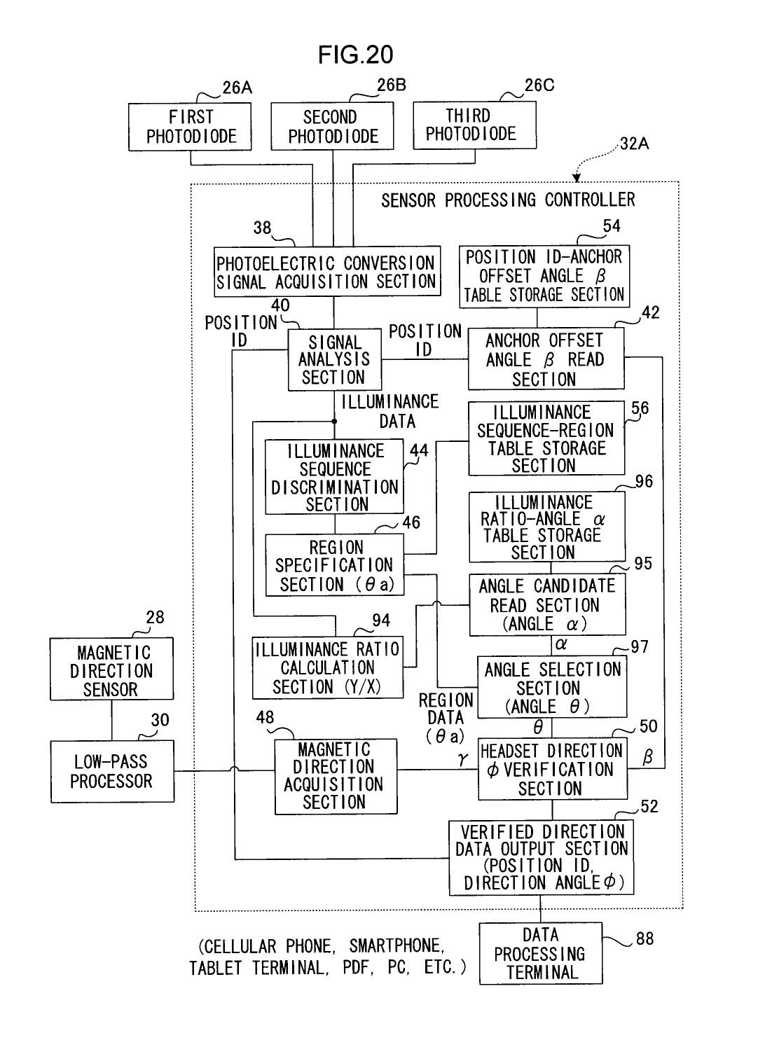

FIG. 20 is a system diagram of a sensor processing controller 32A according to the second exemplary embodiment.

The signal analysis section 40 is connected to an illuminance ratio calculation section 94. Photoelectric conversion signals based on the light detected by the first photodiode 26A, the second photodiode 26B, and the third photodiode 26C respectively, are transmitted from the signal analysis section 40 to the illuminance ratio calculation section 94.

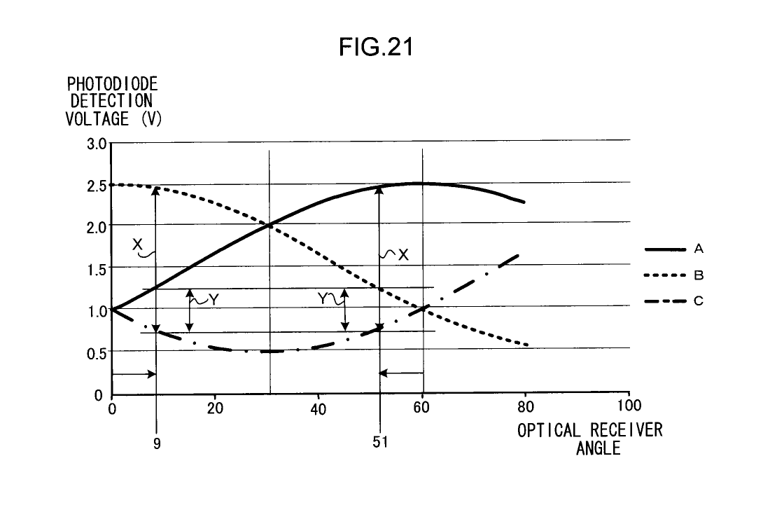

As illustrated in FIG. 21, the illuminance ratio calculation section 94 calculates an illuminance ratio (Y/X) of a difference (Y) between the intermediate value and the lowest value of the photodiode detection voltage, against a difference (X) between the greatest value and the lowest value of the photodiode detection voltage.

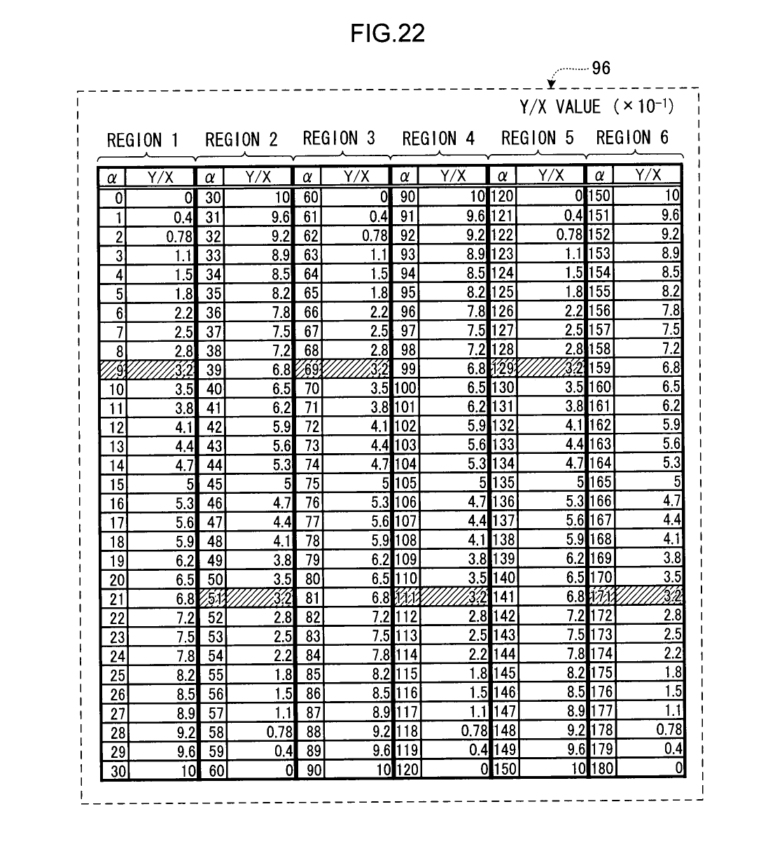

The illuminance ratio calculation section 94 is connected to an angle candidate read section 95. Moreover, an illuminance ratio-angle α table storage section 96 is connected to the angle candidate read section 95. As illustrated in FIG. 22, the illuminance ratio-angle α table storage section 96 stores a correlation table of the illuminance ratios at predetermined angle units (1° units in the second exemplary embodiment). Note that “×10⁻¹” is omitted from the calculated values of Y/X in FIG. 22.

The angle candidate read section 95 accordingly reads the angle α matching the illuminance ratio received from the illuminance ratio calculation section 94 from the correlation table stored in the illuminance ratio-angle α table storage section 96. The read angle α is transmitted to an angle selection section 97.

The angle selection section 97 acquires the specified region data (the region θa) from the region specification section 46, and selects an angle θ indicating the detailed heading of the user 80 from the acquired region θa and the angle α.

For example, when the illuminance ratio Y/X is 3.2×10⁻¹, there are six candidates for the angle α (9°, 51°, 69°, 111°, 129°, and 171°). These six candidates are distributed across the six respective regions θa, and if the regions θa (region 1 to region 6) have been determined, then the angles θ, one of which being the heading of the user, can be selected as follows.

Region 1: θ=0°+α=9°

Region 2: θ=60°−α=51°

Region 3: θ=60°+α=69°

Region 4: θ=120°−α=111°

Region 5: θ=120°+α=129°

Region 6: θ=180°−α=171°

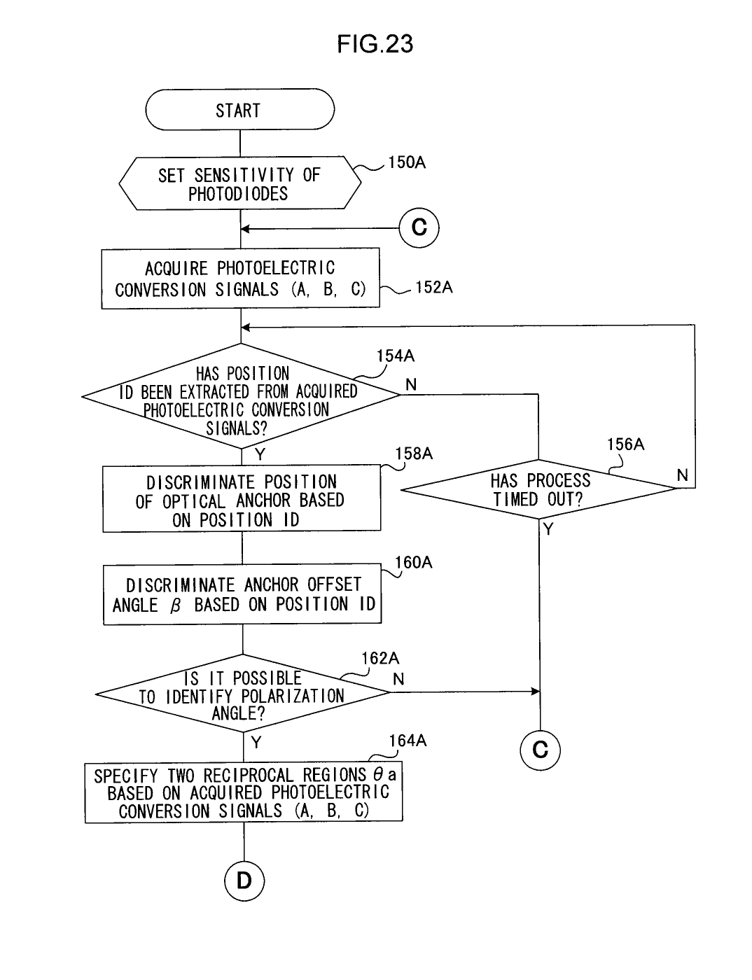

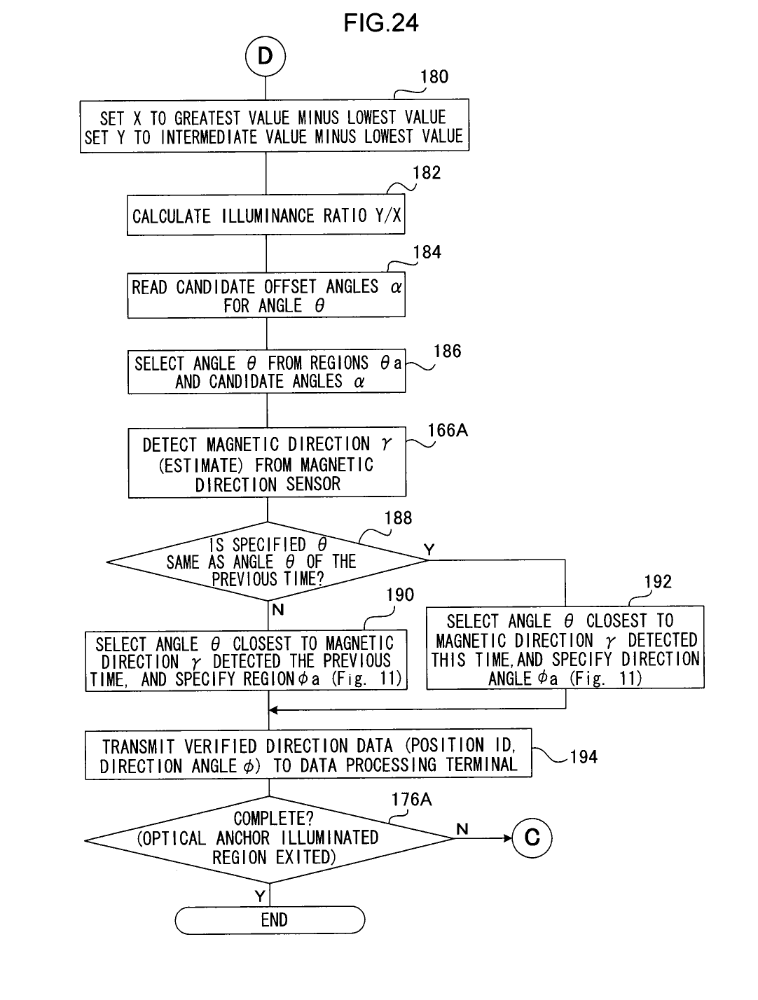

Explanation follows regarding the operation of the second exemplary embodiment according to the flowchart of FIG. 23 and FIG. 24. Note that FIG. 23 corresponds to FIG. 19 of the first exemplary embodiment, and FIG. 24 corresponds to FIG. 20 of the first exemplary embodiment. Similar processing steps are appended with the same reference numeral suffixed with “A”, and explanation thereof is omitted.

When two regions θa are specified at step 164A of FIG. 23, processing transitions to step 180 of FIG. 24.

As illustrated in FIG. 24, at step 180, the difference X between the greatest value and the lowest value, and the difference Y between the intermediate value and the lowest value are calculated based on the photoelectric conversion signals from the first photodiode 26A, the second photodiode 26B, and the third photodiode 26C.

At the next step 182, the ratio Y/X is calculated for Y against X that are calculated at step 180.

As illustrated in FIG. 21, since the photoelectric conversion signals (detection voltages) change (as sine waves) while having phases shifted with respect to each other according to the heading of the optical receiver 14 (the heading of the headset 82 worn by the user 80), the ratio Y/X is a value that varies with the heading.

At the next step 184, the angle α candidates for each region (region 1 to region 6) are read, based on the illuminance ratio-angle α table stored in the illuminance ratio-angle α table storage section 96 (see FIG. 22), and processing then transitions to step 186.

At step 186, the angle θ is selected, from the regions θa specified at step 164A and the angles α, and processing transitions to step 166A.

At step 166A, the magnetic direction γ is detected from the magnetic direction sensor 28, and processing transitions to step 188.

At step 188, determination is made as to whether or not the change difference Δ between the angle θ specified this time and the angle θ specified the previous time is a specific value or lower. This is to recognize a state of change in heading due to head oscillation or the like of the user 80.

Since negative determination at step 188 indicates an abrupt change in the heading of the user 80, determination is made that the detected magnetic direction is unstable (see FIG. 12, FIG. 13). Processing then transitions to step 190, the angle θ closest to the magnetic direction γ detected the previous time is selected, the direction angle φ is specified (see FIG. 11), and processing transitions to step 194.

Since affirmative determination is made at step 188 indicates there is little change in the heading of the user 80, determination is made that the detected magnetic direction is stable (see FIG. 12, FIG. 13). Processing then transitions to step 192, the angle θ closest to the magnetic direction γ detected the previous time is selected, the direction angle φ is specified (see FIG. 11), and processing transitions to step 194.

At step 194, the verified position data (the position ID (the position coordinates of the optical anchor 12) and the direction angle φ) are transmitted to the data processing terminal 88, and processing transitions to step 176A. After receiving the verified direction data, the data processing terminal 88, for example, specifies from a database the exhibit 72 (or 74) present in the direction the user 80 is facing, and the data for the exhibit 72 (or 74) is downloaded and presented to the user 80. Note that the data may be received from the exhibit 72 (or 74) directly.

At step 176A, determination is made as to whether or not the illuminated region (light flux area) of the optical anchor 12 has been exited, and when negative determination is made, processing returns to step 152 and the above processes are repeated. The present routine ends when affirmative determination is made at step 176A.

### Third Exemplary Embodiment

Explanation follows regarding the third exemplary embodiment. In the third exemplary embodiment, configuration portions similar to those described in the first exemplary embodiment and the second exemplary embodiment are appended with the same reference numeral, and explanation of the configuration thereof is omitted.

In the third exemplary embodiment, the polarization angles of the linear polarizing filters of the optical receiver 14 configured in the first exemplary embodiment as described above, are divided into five divisions.

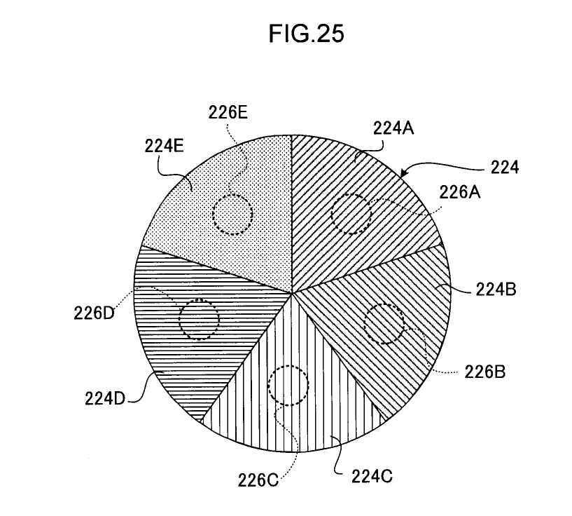

As illustrated in FIG. 25, the light reception face 14A of the optical receiver 14 is provided with a circular plate shaped linear polarizing filter 224 divided into five around the circumferential direction. Namely, first to fifth linear polarizing filters 224A to 224E are each fan-shaped with 72° center angles.

Thus, the first to fifth linear polarizing filters 224A to 224E have polarization directions differing from each another in units of 36°.

The linearly polarized light illuminated from the optical anchor 12 passes through the first to fifth linear polarizing filters 224A to 224E, and is received and photoelectrically converted by first to fifth photodiodes 226A to 226E provided facing the respective first to fifth linear polarizing filters 224A to 224E.

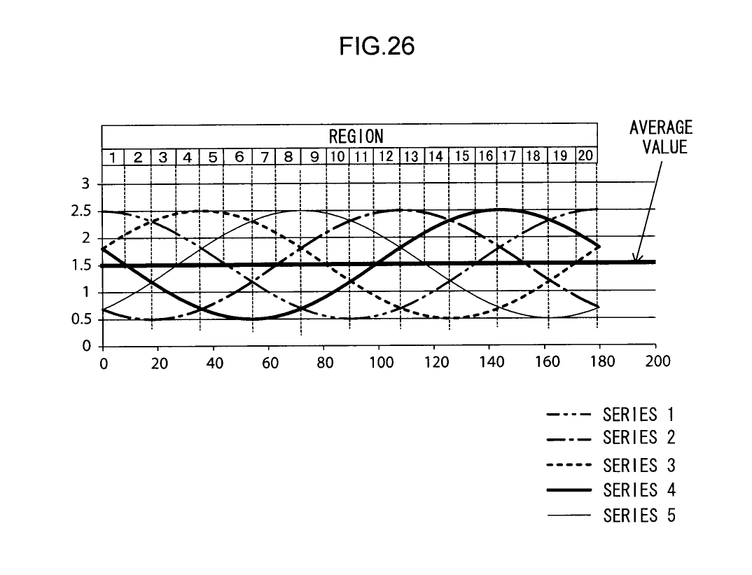

FIG. 26 illustrates the detection voltage characteristics when the first to fifth linear polarizing filters 224A to 224E are rotated through 180°, based on the photoelectric conversion signals of the first to fifth photodiodes 226A to 226E.

As is apparent from FIG. 26, peak values are present for the respective first to fifth photodiodes 226A to 226E (points of maxima at five locations) in a range of from 0° to 180°. The photodiode corresponding to the detection voltage giving the peak value therefore continues to be the greatest detection voltage over an angle range of 36° centered about the corresponding peak value.

The photodiode continuing over this angle range is denoted A channel, and two photodiodes, denoted B channel and C channel, are selected that intersect at the angle of the peak value and bisect the angle range of the A channel. “Channel” is sometimes shortened to “ch” below.

As a result, at the regions of the five locations, mutually different selections are made of an A channel, a B channel, and a C channel.

In the regions of the five locations, the number of photodiodes exceeding the average value of the detection voltage is sometimes two, and sometimes three.

In consideration of the above, setting may be made as in Table 2 below when specifying the regions.

TABLE 2

| Number exceeding | No. of | No. of | No. of | |
|---|---|---|---|---|
| average value | greatest ch | second ch | third ch | Region θa |
| 3 | 1 | 3 | 4 | 1 |
| 2 | 1 | 3 | 4 | 2 |
| 2 | 3 | 1 | 5 | 3 |
| 3 | 3 | 1 | 5 | 4 |
| 3 | 3 | 5 | 1 | 5 |
| 2 | 3 | 5 | 1 | 6 |
| 2 | 5 | 3 | 2 | 7 |
| 3 | 5 | 3 | 2 | 8 |
| 3 | 5 | 2 | 3 | 9 |
| 2 | 5 | 2 | 3 | 10 |
| 2 | 2 | 5 | 4 | 11 |
| 3 | 2 | 5 | 4 | 12 |
| 3 | 2 | 4 | 5 | 13 |
| 2 | 2 | 4 | 5 | 14 |
| 2 | 4 | 2 | 1 | 15 |
| 3 | 4 | 2 | 1 | 16 |
| 3 | 4 | 1 | 2 | 17 |
| 2 | 4 | 1 | 2 | 18 |
| 2 | 1 | 4 | 3 | 19 |
| 3 | 1 | 4 | 3 | 20 |

According to the second exemplary embodiment, five types of linear polarizing filter having respectively different linear polarization directions, and corresponding photodiodes, are disposed in the optical receiver 14.

The headings of the user 80 are classified into 20 (the number of photodiodes×4) regions θa according to the intensity sequence of the detection voltages from the photodiodes of the three selected channels, enabling the specification of the direction angle φa with a resolution of 180°÷20=9°.

Although points of maxima are employed as the peak values in the third exemplary embodiment, the same result may also be obtained when points of minima are selected. In such cases, the number below the average value may be counted.

Although the polarization angles of the linear polarizing filters in the optical receiver 14 are divided into 5 divisions in the second exemplary embodiment, there may be seven divisions or nine divisions.

### Modified Example 1

### Seven Divisions

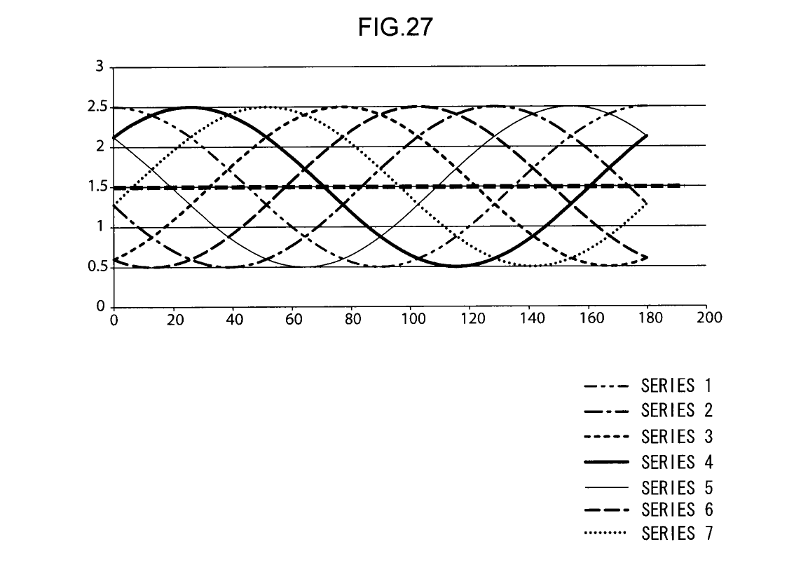

FIG. 27 illustrates detection voltage characteristics based on photoelectric conversion signals of seven photodiodes when seven linear polarizing filters are rotated through 180°.

As illustrated in FIG. 27, peak values (at seven locations) are present for the seven respective photodiodes, in a range of from 0° to 180°. The photodiode corresponding to the detection voltage giving the peak value therefore continues to be the greatest detection voltage over a given angle range centered about the corresponding peak value.

The photodiode continuing over this angle range is denoted A channel, and two types of photodiode, denoted B channel and C channel, are selected that intersect at the angle of the peak value, bisecting the angle range of the A channel.

As a result, mutually different selections are made for the A channel, B channel, and C channel regions at the seven locations.

The number of photodiodes exceeding the average value of the detection voltage in the regions at the seven locations is sometimes three, and sometimes four.

The headings of the user 80 are classified into 28 (the number of photodiodes×4) regions θa according to the intensity sequence of the detection voltages from the photodiodes of the three selected channels, enabling specification of the direction angle φa with a resolution of 180°÷28=6.4°.

### Modified Example 2

### Nine Divisions

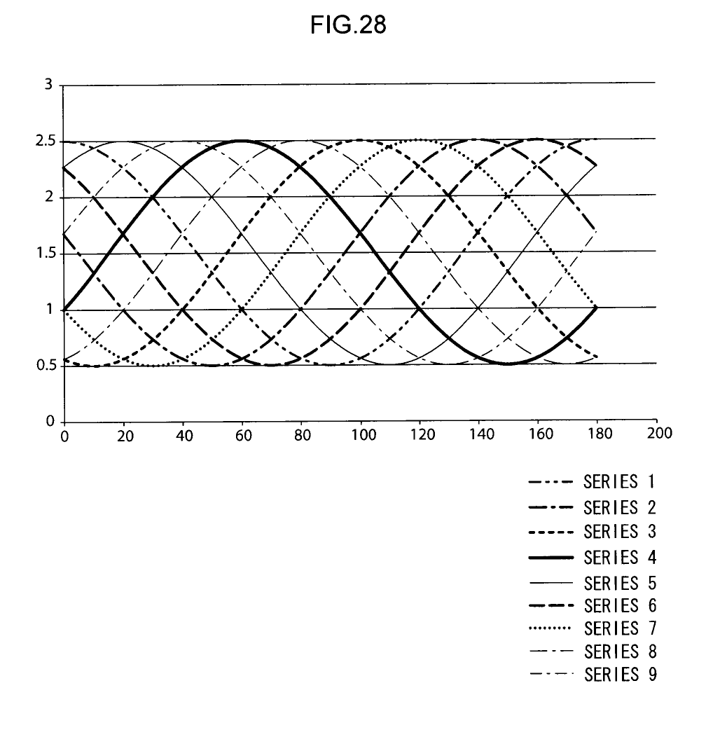

FIG. 28 illustrates detection voltage characteristics based on photoelectric conversion signals of nine photodiodes when nine linear polarizing filters are rotated through 180°.

As illustrated in FIG. 28, peak values (at nine locations) are present for the nine respective photodiodes, in a range of from 0° to 180°. The photodiode corresponding to the detection voltage giving the peak value therefore continues to be the greatest detection voltage in a given angle range centered about the corresponding peak value.

The photodiode continuing over this angle range is denoted A channel, and two types of photodiode, denoted B channel and C channel, are selected that intersect at the angle of the peak value, bisecting the angle range of the A channel.

As a result, mutually different selections are made of the A channel, B channel, and C channel in the regions of nine locations.

The number of photodiodes exceeding the mean value of the detection voltage in the regions at the nine locations is sometimes four, and sometimes five.

The headings of the user 80 are classified into 36 (the number of photodiodes×4) regions θa according to the intensity sequence of the detection voltages from the photodiodes of the three selected channels, enabling specification of the direction angle φa with a resolution of 180°÷36=5°.

The number of divisions for the linear polarizing filters in the second exemplary embodiment (including Modified Example 1 and Modified Example 2) is not limited, and in theory, may be any number N (where N is a natural number of three or more). For example, the regions may be divided into the number of divisions structurally possible for manufacture of the linear polarization filter unit.

Disclosures herein are not limited to the numerical values used in the above explanations.

Herein, as an example it is supposed that in an exhibition hall displaying plural exhibits, users are provided with wearable headsets to which output devices such as a monitor and earphones are installed, and data is presented related to the exhibit that the user is facing.

In such cases, technology that specifies position data using polarized light is able to recognize relative angles of two predetermined positions, but is unable to then recognize which of the plural exhibits is being faced (the direction). Although a mobile terminal with a direction detection function employing geomagnetism has been proposed, in direction detection functions employing geomagnetism, for example, sometimes it is not possible to ensure responsiveness to changes caused by sporadic head oscillation by the user.

On the other hand, according to the disclosures discussed herein, a position relative to plural target objects is accurately recognized in real time.

All publications, patent applications and technical standards mentioned in the present specification are incorporated by reference in the present specification to the same extent as if the individual publication, patent application, or technical standard was specifically and individually indicated to be incorporated by reference.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A direction discrimination device, comprising:
an illumination section that is disposed with an established first reference direction, that includes a light source emitting light of a predetermined polarization direction towards a specific region, and that superimposes polarization direction data identifying the polarization direction onto the emitted light and outputs the data-superimposed light;
an optical receiver section that includes a plurality of photoelectric conversion sections outputting electrical signals according to an amount of light received as light reception amount data, and a polarization section causing mutually different polarization directions for light receivable by the plurality of respective photoelectric conversion sections, and that has an established second reference direction specifying the heading of each of the photoelectric conversion sections when receiving light; and
a discrimination section that discriminates an angular displacement of the second reference direction with respect to the first reference direction, based on the light reception amount data obtained by the plurality of photoelectric conversion sections in the specific region and the polarization direction data extracted from received light.

2. The direction discrimination device of claim 1, further comprising a magnetic direction region detection section that, when the optical receiver section receives light from the light source in the specific region, detects whether the second reference direction of that optical receiver section is assigned to one magnetic direction region arising from a division at least in half into 180° units.

3. The direction discrimination device of claim 2, wherein the illumination section is affixed at a given position, and position data identifying the position of the light source is superimposed on the light emitted from the light source.

4. The direction discrimination device of claim 3, wherein:
a wearable item including at least the optical receiver section and the magnetic direction region detection section is worn on the head of a wearer; and
the discrimination section discriminates the heading of the head of the wearer based on the angular displacement of the second reference direction, and the position data extracted from received light.

5. The direction discrimination device of claim 3, wherein:
a wearable item including at least the optical receiver section and the magnetic direction region detection section is worn on the head of a viewer moving through an exhibition hall to view exhibits;
relative positional relationships between the illumination section and each of a plurality of the exhibits displayed in the exhibition hall are pre-stored in a storage section; and
an exhibit present in front of the heading of the head of the appreciator is specified based on the angular displacement of the second reference direction discriminated by the discrimination section, and the position data extracted from received light.

6. The direction discrimination device of claim 2, wherein high frequency components of the detection signal in a case where the magnetic direction varies are removed by a low-pass filter, and in the magnetic direction region detection section, magnetic direction data is acquired in a case where a predetermined variation or less has continued during a time period in which the detection signal converges.

7. The direction discrimination device of claim 1, wherein the discrimination section:
designates the photoelectric conversion section having the greatest or the lowest light reception amount out of N photoelectric conversion sections as an A channel (wherein N is a natural number of 3 or more), respectively designates as a B channel and a C channel two photoelectric conversion sections that have light reception amounts intersecting at an angle bisecting the range over which the light reception amount of the photoelectric conversion section of the A channel is continuously the greatest or the lowest; and
discriminates the angular displacement of the second reference direction of the optical receiver section based on a sequence of the light reception amounts of the A channel, the B channel, and the C channel.

8. The direction discrimination device of claim 7, wherein, in addition to the sequence of the light reception amounts of the A channel, the B channel, and the C channel, the discrimination section discriminates the angular displacement of the reference direction also based on a number of photoelectric conversion sections, out of the N photoelectric conversion sections (wherein N is an odd number of 5 or more), that are specified as having a light reception amount surpassing or falling below an average value of the N light reception amounts.

9. The direction discrimination device of claim 5, wherein the exhibition hall is indoors, the illumination section is affixed to a ceiling surface of the indoor exhibition hall, and the polarization direction data is an angle in plan view between a predetermined magnetic direction and the polarization direction.

10. The direction discrimination device of claim 9, wherein a relative positional relationship between the illumination section and a plurality of exhibits is databased as plan view X-Y coordinates taking the illumination section affixed to the ceiling as the origin.

11. The direction discrimination device of claim 1, wherein the photoelectric conversion section is a photodiode.

12. The direction discrimination device of claim 1, wherein the polarization section is a linear polarizing filter.

13. A direction discrimination method, comprising:
superimposing, onto light emitted from a light source that is disposed with an established first reference direction and emits light of a predetermined polarization direction towards a specific region, polarization direction data identifying the polarization direction, and outputting the data-superimposed light;
causing the output light to have mutually different receivable polarization directions, and receiving the output light with a plurality of photoelectric conversion sections set with a reference direction specifying the heading when receiving light; and
discriminating an angular displacement of a second reference direction with respect to the first reference direction, based on light reception amount data obtained by the plurality of photoelectric conversion sections in the specific region and the polarization direction data extracted from received light.

14. The direction discrimination method of claim 13, further comprising:
designating the photoelectric conversion section having the greatest or the lowest light reception amount out of N photoelectric conversion sections as an A channel (wherein N is a natural number of 3 or more), respectively designating as a B channel and a C channel two photoelectric conversion sections that have light reception amounts intersecting at an angle bisecting the range over which the light reception amount of the photoelectric conversion section of the A channel is continuously the greatest or the lowest; and
discriminating the angular displacement of the reference direction based on a sequence of the light reception amounts of the A channel, the B channel, and the C channel.

15. The discrimination method of claim 14, wherein, in addition to the sequence of the light reception amounts of the A channel, the B channel, and the C channel, the discriminating of the angular displacement of the reference direction is also based on a number of photoelectric conversion sections, out of the N photoelectric conversion sections (wherein N is an odd number of 5 or more), that are specified as having a light reception amount surpassing or falling below an average value of the N light reception amounts.

16. A non-transitory recording medium storing a program that causes a computer to execute a direction discrimination control process, the process comprising:
superimposing, onto light emitted from a light source that is disposed with an established first reference direction and emits light of a predetermined polarization direction towards a specific region, polarization direction data identifying the polarization direction, and outputting the data-superimposed light;
causing the output light to have mutually different receivable polarization directions, and receiving the output light with a plurality of photoelectric conversion sections set with a reference direction specifying the heading when receiving light; and
discriminating an angular displacement of a second reference direction with respect to the first reference direction, based on light reception amount data obtained by the plurality of photoelectric conversion sections in the specific region and the polarization direction data extracted from received light.

17. The non-transitory recording medium of claim 16, wherein the process further comprises:
designating the photoelectric conversion section having the greatest or the lowest light reception amount out of N photoelectric conversion sections as an A channel (wherein N is a natural number of 3 or more), respectively designating as a B channel and a C channel two photoelectric conversion sections that have light reception amounts intersecting at an angle bisecting the range over which the light reception amount of the photoelectric conversion section of the A channel is continuously the greatest or the lowest; and
discriminating the angular displacement of the reference direction based on a sequence of the light reception amounts of the A channel, the B channel, and the C channel.

18. The non-transitory recording medium of claim 17, wherein, in addition to the sequence of the light reception amounts of the A channel, the B channel, and the C channel, the discriminating of the angular displacement of the reference direction is also based on a number of photoelectric conversion sections, out of the N photoelectric conversion sections (wherein N is an odd number of 5 or more), that are specified as having a light reception amount surpassing or falling below an average value of the N light reception amounts.
